(19) United States
(12) Patent Application Publication
(10) Pub. No.: US 2026/0317035 A1
(43) Pub. Date: Oct. 15, 2026

(54) INTELLIGENT INSULATED BAG WITH REVERSIBLE THERMOCHROMIC INDICATOR AND UV PROTECTION

(71) Applicants: JAVIER FRANCISCO LAZARO FERRE, Barcelona (ES); CATHERINE BERTIN, Barcelona (ES); VICTOR LAZARO BERTIN, Barcelona (ES); OSCAR LAZARO BERTIN, Barcelona (ES); Robert G. Suber, Columbia, SC (US)

(72) Inventor: Francisco Javier Lázaro Ferré, Barcelona (ES)

(73) Assignees: JAVIER FRANCISCO LAZARO FERRE, Barcelona (ES); CATHERINE BERTIN, Barcelona (ES); VICTOR LAZARO BERTIN, Barcelona (ES); OSCAR LAZARO BERTIN, Barcelona (ES); Robert G. Suber, Columbia, SC (US)

(21) Appl. No.: 19/642,782

(22) Filed: Apr. 9, 2026

(30) Foreign Application Priority Data
Apr. 10, 2025 (FR) FR2503831

(51) Int. Cl. B65D 79/02; B32B 1/00; B32B 5/18; B41M 1/26; B41M 3/00; B41M 7/00; B65D 81/38; G01K 11/12

(52) U.S. Cl. CPC B65D 79/02; B32B 1/00; B32B 5/18; B41M 1/26; B41M 3/006; B41M 7/0027; B65D 81/389; B65D 81/3897; G01K 11/12; B32B 2255/10; B32B 2266/025; B32B 2307/304; B32B 2307/412; B32B 2439/06

(57) ABSTRACT

An intelligent insulated bag for transporting frozen or refrigerated products includes a reversible thermochromic indicator that changes color at a predetermined temperature to indicate a break in the cold chain. The reversible thermochromic indicator is printed on an inner surface of a transparent outer layer and protected by a UV-resistant varnish. The bag comprises a multilayer structure including an insulating intermediate layer and a food-grade inner layer.

### CROSS-REFERENCE TO RELATED APPLICATIONS

This application claims priority to and the benefit of France Patent Application Serial No. FR2503831, filed Apr. 10, 2025, the entire disclosure of which is incorporated herein by reference.

### STATEMENT REGARDING FEDERALLY SPONSORED R & D

Not Applicable

### THE NAMES OF THE PARTIES TO A JOINT RESEARCH AGREEMENT

Not Applicable

### REFERENCE TO A “SEQUENCE LISTING,” A TABLE, OR A COMPUTER PROGRAM

Not Applicable

### STATEMENT REGARDING PRIOR DISCLOSURES BY AN INVENTOR OR JOINT INVENTOR

Not Applicable

### SUMMARY OF THE INVENTION

The present invention provides an intelligent insulated bag (100) comprising a reversible thermochromic indicator (210) such as an ink or pigment configured to change color at a predetermined temperature, preferably about 0 °C.

The thermochromic indicator (210) such as an ink is printed on an inner surface (220) of a transparent outer layer (200), thereby protecting the thermochromic indicator (210) such as an ink from direct exposure to air and mechanical wear. A UV protective varnish (230) is applied over the thermochromic indicator (210) such as an ink to prevent degradation due to solar radiation.

The bag (100) further includes an insulating intermediate layer (300) and a food-grade inner layer (400), providing thermal performance and suitability for food (90) transport.

### BRIEF DESCRIPTION OF THE SEVERAL VIEWS OF THE DRAWING

FIG. 1 is a perspective view of the insulated bag (100) showing a visible thermochromic indicator (210);

FIG. 2 is a cross-sectional view illustrating the multilayer structure of the bag (100);

FIG. 3 illustrates a color change of the thermochromic indicator (210) at approximately 0 °C.

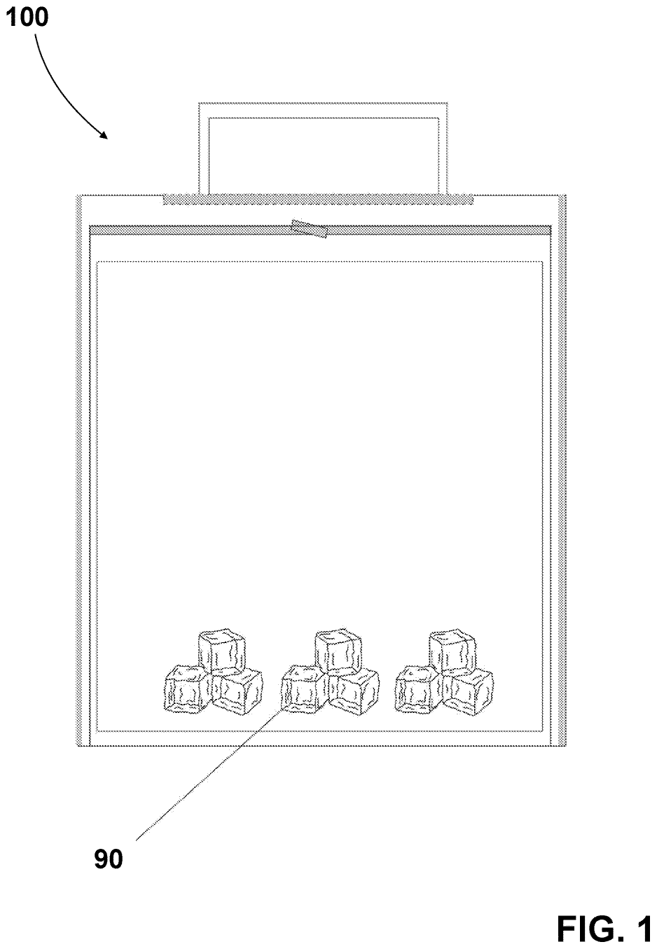

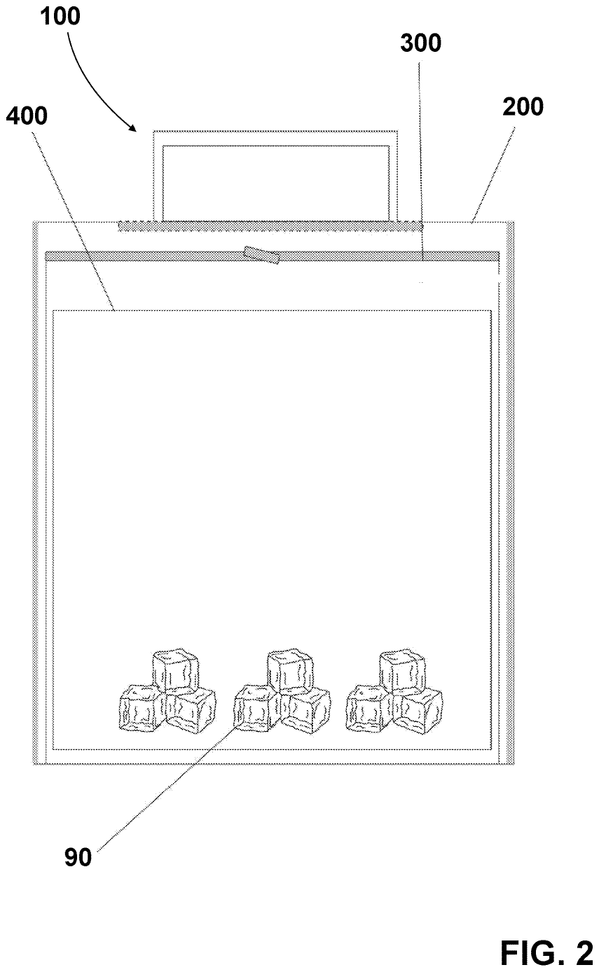

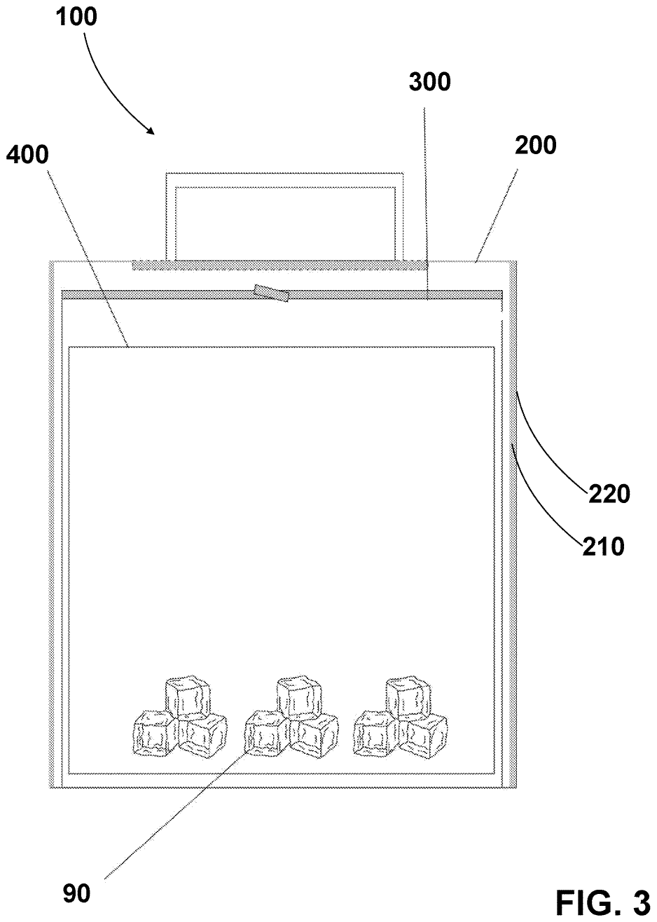

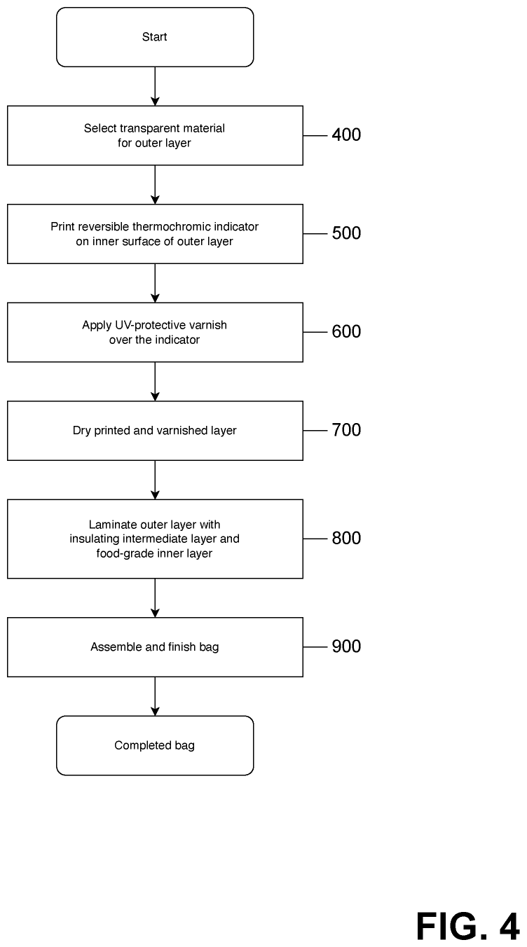

### BACKGROUND

### 1 Field of Use

The present invention relates generally to insulated containers for temperature-controlled transport, and more particularly to an intelligent insulated bag (100) incorporating a reversible thermochromic indicator (210) protected from ultraviolet radiation for monitoring cold-chain integrity.

### 2 Introduction

Insulated bags are commonly used for transporting frozen or refrigerated products, particularly food items (90). However, conventional insulated bags do not provide any visual indication of whether a critical temperature threshold has been exceeded during transport.

Thermochromic inks capable of changing color at predefined temperatures are known in the art. When such inks are applied to an external surface, they are subject to degradation caused by ultraviolet radiation, oxidation, and mechanical abrasion, which significantly reduces their reliability and useful life.

### DETAILED DESCRIPTION OF THE INVENTION

### 1 Structural Description

Referring to the drawings, the insulated bag (100) includes a transparent outer layer (200) formed from a material selected from polyethylene terephthalate (PET), transparent polypropylene, polyethylene, or transparent polyester.

A reversible thermochromic indicator (210) is printed on an inner surface (220) of the transparent outer layer (200) using screen printing, pad printing, flexographic printing, or an equivalent printing technique. A UV-protective varnish (230) is applied over the reversible thermochromic indicator (210) to prevent degradation due to ultraviolet radiation. The reversible thermochromic indicator (210) can be an ink or a pigment.

An insulating intermediate layer (300), preferably polyethylene foam or bubble film, is laminated to the outer layer. A food-grade inner layer (400) forms the interior of the bag (100) and is suitable for direct contact with food products (90).

The reversible thermochromic indicator (210) reversibly changes color when the temperature rises above the predetermined threshold, thereby providing a clear visual indication of a break in the cold chain.

### 2 Manufacturing Method

A method for manufacturing the insulated bag comprises:
1. selecting a transparent material for an outer layer (400);
2. printing a reversible thermochromic indicator such as an ink on an inner surface of the outer layer (500);
3. applying a UV-protective varnish over the ink (600);
4. drying the printed and varnished layer (700);
5. laminating the outer layer with an insulating intermediate layer and a food-grade inner layer (800; and
6. assembling and finishing the bag (900).

I claim:

1. An intelligent insulated bag, comprising:
(a) a transparent outer layer;
(b) a reversible thermochromic indicator printed on an inner surface of the transparent outer layer, the reversible thermochromic indicator being configured to change color at a predetermined temperature;
(c) a UV-protective varnish applied over the ink or pigment;
(d) an insulating intermediate layer; and
(e) a food-grade inner layer.

2. The bag of claim 1, wherein the reversible thermochromic indicator is a pigment or a dye.

3. The bag of claim 1, wherein the predetermined temperature is approximately 0 °C.

4. The bag of claim 1, wherein the reversible thermochromic indicator is applied by screen printing, pad printing, or flexographic printing.

5. The bag of claim 1, wherein the insulating intermediate layer comprises polyethylene foam or bubble film.

6. A method for manufacturing an intelligent insulated bag, comprising:
(a) printing a reversible thermochromic indicator on an inner surface of a transparent outer layer,
(b) applying a UV-protective varnish,
(c) laminating the outer layer with an insulating intermediate layer and a food-grade inner layer, and
(d) assembling the bag.
